(19) United States
(12) Patent Application Publication
(10) Pub. No.: US 2016/0162512 A1
(43) Pub. Date: Jun. 9, 2016

(54) Method for the Creation of Databases of Events Having a Mediatic Echo in the Internet

(71) Applicant: UNIVERSITA' DEGLI STUDI DI FIRENZE, Firenze (IT)

(72) Inventors: Alessandro BATTISTINI, CESENA (IT); Nicola CASAGLI, VAGLIA (IT); Sandro MORETTI, SAN CASCIANO (IT)

(21) Appl. No.: 14/905,111

(22) PCT Filed: Jul. 15, 2014
(86) PCT No.: PCT/IB2014/001328

§ 371 Date: Jan. 14, 2016

(30) Foreign Application Priority Data
Jul. 15, 2013 (IT) PI2013A000070

(51) Int. Cl. G06F 17/30; G06Q 50/26

(52) U.S. Cl. CPC G06F 17/30241; G06F 17/30539; G06F 17/30598; G06F 17/30289; G06F 17/30345; G06Q 50/26

(57) ABSTRACT

A method for the automatic creation and updating of databases of events that have a mediatic echo in the internet in particular hazardous geological events, including the acquisition of information from the internet, their aggregation and processing by specific data mining techniques to locate news about a geological event or similar and create a correspondence between the news and the event itself by associating the latter corresponding information features such as the geographic location, the date and intensity.

### TECHNICAL FIELD

The present invention concerns a method to automatically create and constantly update databases of events that have a mediatic echo in the internet, in particular, hazardous geological events such as landslides, earthquakes, floods.

STATE OF THE ART

### Geological hazards, including earthquakes, floods and landslides, are a major source of mortality and economic damage and strong efforts are then made to mitigate the consequences.

In the study of geological hazards, especially on a regional or national level, it is of primary importance the availability of archives and databases that can provide information on past and recent events such as the intensity, timing and location.

In particular, the availability of up to date and complete databases was essential for the assessment of hazards and risks and the development of early warning models. Unfortunately, one of the main limitations of the existing archives and databases (particularly for landslides and floods) is their speed and method for updating: usually they are compiled manually on the basis of field surveys and, sometimes, by means of remote sensing. Systems with automatic updates and/or real-time are still rare and only linked to certain types of geological hazards.

The “earthquakes” are the type of natural disaster that can rely on methods of geo-localization and characterization of the most effective and fast. Indeed, there is a worldwide network of sensors and processing stations that is able to record the occurrence of large and medium-scale events and to locate them in real time. In addition, several national agencies provide, in real time, the same information on a national scale for smaller events.

The “flooding” are a type of hazardous geological event usually well known and documented. Nevertheless, the study of floods and flood risk in general, requires the use of long series of events. Most countries relies on a number of measuring stations able to monitor the levels of water and fluvial discharges with high accuracy. Many national or regional hydrological services have kept track of these values for decades or centuries, allowing their use for scientific purposes.

The creation of complete and up to date databases is a more complex problem in the case of the “landslide” type hazardous geological event. In this context, great efforts are needed not only for the development of models and their application, but also to collect complete data. Despite this, they are currently operating several databases related to the geohazard “landslide”, but even if they can be considered as very useful tools for hazard estimates and impact on society, they are characterized by a significant degree of incompleteness since they include almost exclusively major events with catastrophic effects. At the national level there are several archives but such tools, although very useful, have some drawbacks that prevent their widespread use in the study of landslides: they are updated intermittently and rarely provide systematic information about the temporal location of the landslide phenomenon (therefore they may not be useful for calibration/validation of predictive models).The collection of data related to a landslide can be a very challenging task, regardless of whether it is accomplished by means of field surveys, using remote sensing techniques or through manual retrieval of information from newspapers or technical reports, and therefore requires a considerable amount of time and human resources.

They are certainly known techniques and methods of data mining, which allow, in general, to extract by analytical techniques at the state of the art, the hidden implicit information from data already structured to make it available and directly usable. However, it is far from trivial to apply these methods to study data mining techniques to obtain specific information on hazardous geological events from data tracked on the Internet.

A method to create a database about occurrences of avian influenza realized through information found on the Internet is described in the document “Web based tool for the Detection and Analysis of Avian Influenza Outbreaks from Internet News Sources” Ian Turton et al in the acts of “The 17th Research Symposium on Computer-based Cartography”, of Sep. 8, 2008. In this document it is described the use of three data sources (RSS feed) one of which is a news site dedicated to the subject, and therefore does not need filtering queries, while in the others are used queries that have a single one specific search keyword: “H5N1 avian influenza.” The geographical location of the news is executed looking for the match in the database of names called “GeoNames” so the news is localizable only if it is traced in at least one place name contained in GeoNames. The proposed method allows you to archive the news event together to its location and the date of publication, however they can not get information about the intensity of the event, the reliability of the positioning, the inherence of the news with the topic of interest, and the difference in time between the date of publication of the news and date of occurrence of the event it reports.

The document “Extracting and Exploring the Geo-Temporal Semantics of Textual Resources” describes a methodology of data mining for the extraction of geo-temporal information from text, and in particular describes an example of application to texts tracked on the internet and collected in RSS feeds. This paper describes the application of data mining techniques to determine indices of reliability of positioning and timing differences between the publication of the news and the occurrence of the event. The described method only takes into account geographical and temporal aspects, and also, with regard to the geographical aspect, a limit consists in being supported by the aforementioned database GeoNames, with the inability to perform positioning if it is not traced in GeoNames.

### SUMMARY OF THE INVENTION

It as a main object of the present invention to contribute to fill the above gaps by proposing a method for the creation and automatic updating of databases in a specific type of event having a mediatic echo in the internet, in particular a geological hazardous event, including detailed information on the location and timing of the events and their perceived intensity.

Further object of this invention is to propose a method which, thanks to a peculiar application of data mining techniques, allows to create databases of geological hazardous events from documents pages on the Internet, Where this database is able to provide information on at least: the location of the event, the displacement of the event, the reliability of the location, the intensity of the event and the inherence of the news that relate to the event with the event itself.

The above objects are achieved by a method for the automatic creation and updating of databases on hazardous geological events such as landslides, earthquakes, floods, but potentially expandable to any sector, comprising the steps of:
acquisition of internet news related to a particular type of hazardous geological event, that acquisition taking place thanks to the execution of a feed aggregator based on certain search parameters;
definition of each feed returned as output from such a feed aggregator as an event of that type of event;
association with any feed that does not contain position information of a position information by comparing information contained in said feed with a database of place names;
cataloging of each event in a database of said geological event together with characteristic parameters of said event comprising at least the location of the event, the date of the event, and the intensity of the event, said parameters being determined by using data mining techniques performed on said feed which identifies the occurrence of that event;
cyclic repetition of the previous steps according to a certain time interval.

Advantageously, the step of acquiring news from the internet comprises the steps of:
search on the internet of news, within a given list of web addresses, through feed aggregators, in which the above search is performed depending on a plurality of search parameters;
grouping search results by that feed aggregators through specific algorithms for classification and clustering;
returning the results grouped, each group being expressed in the form of a feed;
interpretation of each feed by a feed reader program;
identification of each feed with an event of said type of hazardous geological events.

Still advantageously said step of associating to a feed a position information includes steps of:
textual comparison of one or more fields in the feed with a database of place names; identifying in said fields of the feed of one or more place names present in said database of place names;
performing of data mining techniques to select, among those place names identified, one or more reference names to be associated with said feed;
choice of the name of the main place name via an appropriate algorithm;
association to feed a GeoTag corresponding to the place name selected in the database of place names, said GeoTag of feed and/or said selected name corresponding to a position information of the event.

Preferably, the aforementioned database of place names provides a list of names of various types including at least the names of towns and small cities, names of administrative units at various levels of aggregation such as districts, provinces and regions, street names, names of rivers, lakes, mountains, and other geographic areas, each of said names being located in a predefined geographic coordinate system and each of them being associated with a geometric definition that can be a point, line or area, such names being organized hierarchically according to a plurality of hierarchical categories.

Advantageously, the method of the invention provides for the location of the feed even in the absence of a name reference, using alternative procedures to search for the location of the news broadcaster, or search for adjectives, geographical indications or equivalences that are not directly expressible as a place name.

The cataloging phase advantageously comprises the steps of:
running on the feed associated with said event data mining techniques suitable to determine appropriate parameters typical of that event and to exclude from this database unreliable events, such data mining techniques including at least:
calculating a “place score” to determine how reliable the GeoTag assigned to the feed; an “event score” to determine the probability that the feed relates to an event of the type sought; a “date score” to determine the relevance of the news function of the distance in time between the occurrence of the event and the publication of the news; a “number of news” to determine the media coverage of the event, indirect index of the intensity of the same;
comparison of the above calculated scores with respective threshold values;
   including the event in this database of hazardous geological events, with each event being associated with at least position, date and intensity information, obtained either directly or through the above-mentioned data mining techniques from said feed of the event.

The proposed approach is based on the idea that every time a hazardous geological event produces a remarkable effect, a news is reported on the internet. Therefore, the recovery of information from the internet allows to have a constantly updated database and the application of appropriate data mining techniques allows to separate the trivial information from the relevant ones. Once the events are identified by the news in the internet via an automated process, each event can be analyzed and cataloged in a database of that specific type of hazardous geological event, along with characteristics of the event (including a reference position and a dating).The procedure for the extraction of data on the internet advantageously retrieves news in RSS (Really Simple Syndication) format and analyzes them to identify an event and its dating. In addition, the comparison with the database of names is used to locate the events in case the feed associated with the event does not already contain information about the location. The procedure for data extraction uses algorithms that are specifically calibrated for a single type of hazardous geological events.

### BRIEF DESCRIPTION OF THE DRAWINGS

These and other features of the invention will be more easily understood from the following description of a preferred embodiment of the invention, given as non-limiting example, with reference to the accompanying figures in which:

FIG. 1 shows a flow chart of the main steps of the method of the invention;

FIG. 2 shows a flow chart of a process of acquiring from the internet news of hazardous geological events according to the present invention;

FIG. 3 shows a flow chart of a process of association to a feed, and then to the event, of position information according to the present invention;

FIG. 4 is a flow chart of a process of cataloging of hazardous geological events in a database of hazardous geological events according to the present invention;

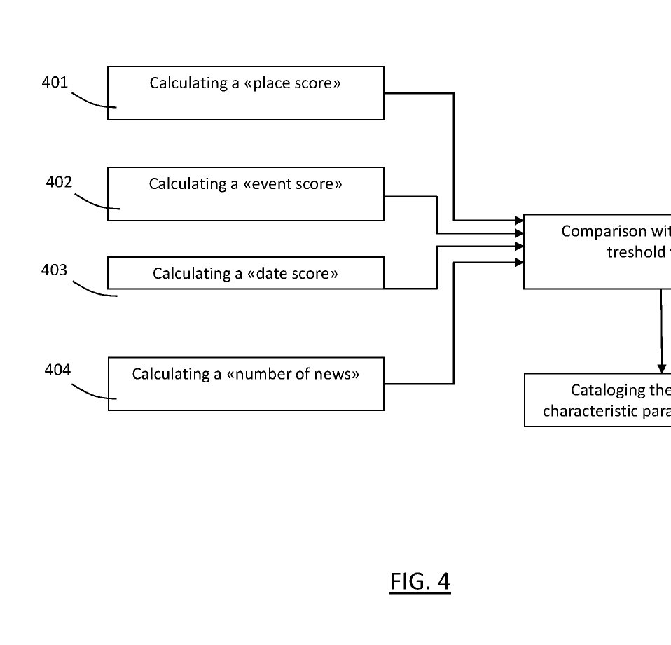

FIG. 5 is a block diagram of a database of names used in a method according to the present invention.

### DESCRIPTION OF PREFERRED EMBODIMENTS

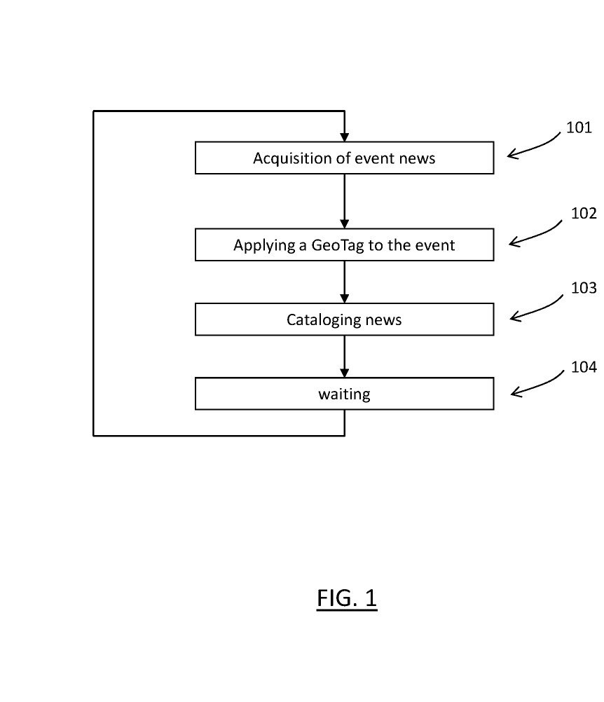

With reference to FIG. 1, a method for the creation and automatic updating of databases on hazardous geological events provides for acquisition by internet of news, 101, relating to a particular type of geological event and the possible aggregation of news about the same event, the association to each event of a position information, 102, and finally the cataloging in a event database, 103, along with the relevant parameters of the event such as the above position information, a information on the dating, and the intensity of the event. After a waiting period, 104, the update of the database occurs by repetition of the above sequence of operations. The repetition of the cycle takes place with a frequency of the order of magnitude of minutes, so that the database can be considered updated almost in real time. The update of the database occurs not only by adding new events and information thereof occurred between the previous update and the last one, but also by updating the information relating to events already in the database.

In the following, it is described a preferred embodiment of the invention, which relates to the mode of creation and updating of databases on the “landslide”, “flood” and “earthquake” type of events with geological risk occurred at national level.

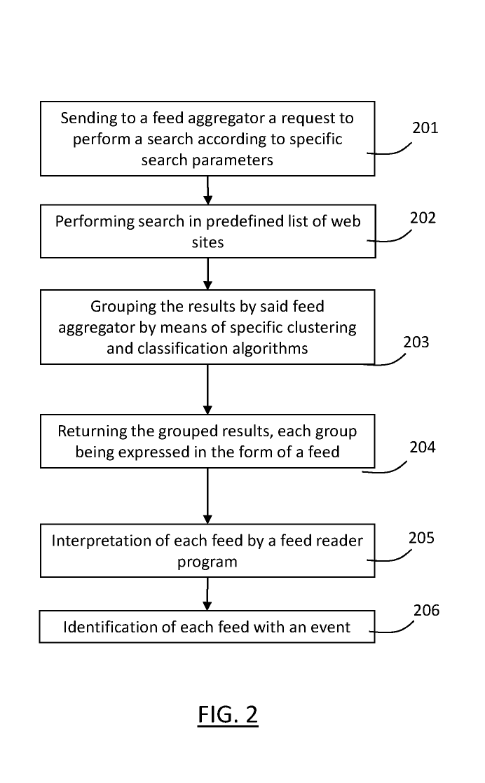

With reference to FIG. 2, the acquisition, 200, of the event news occurs by means of a “feed” reader program which collects feeds from an news aggregator algorithm from web addresses registered in a given list. For example, according to a preferred embodiment of the invention, it is used the “Google News” service as news aggregator, while for reading the feeds are used classes defined by the project “SimplePie”.According to the present invention, Google News can be queried via a web browser or, preferably, as a web service integrated into a feed reader program. The news are sought from web resources contained in a given list that is regularly updated.

Aggregator of feeds is sent to a search request, 201, which is sent along with the parameters of the search to be performed. For example, in Google News all the search parameters can be supplied via a single command string sent in the form of a web address. In the specific case the supplied parameters are: the language in which the document is written, the country of registration of the websites in which to search, the output format of the feed (RSS or Atom), and finally, of course, the words that constitute the topic of the search separated by logical operators. For example, in the creation of a database of “landslide” occurred in Italy it is used a series of synonymous or other terms relating to the type of event, such as landslides, mudslides, slipping. Similarly, the phenomenon of “flooding”, “earthquake”, or other geological events are identified by words or phrases to be inserted in the topic of the search. In contrast, then, to what happens in similar conventional methods, in each search string are used a plurality of keywords including synonyms and variations of the term that defines the event of interest.

The aggregator of feeds searches the web addresses of the above list, 202, selecting documents (news) that match the search criteria entered.

The aggregator then performs a pre-processing of the selected documents using classification and clustering algorithms which take into consideration several factors: e.g. title, text, and time of publication of the news. In this way, various news that relate to a same event are stored in the same feed, 203, counting the number of recorded news in the feed. The feed in RSS format provides a set of information, 204, for example:
Id: unique identifier of the news,
Title: The title of the news;
Content: the content of the news (in HTML format);
Description: summary of the news (in HTML format);
Time: date and time of publication;
Permalink: /connection to the web news or news group;
Lat: latitude of the location of the event (in the case that the feed is in GeoRSS format);
Lon: longitude of the location of the event (in the case that the feed is in GeoRSS format);

The feed is then interpreted by a feed reader, 205. Description contains the first few lines of the news, while Content should include the entire HTML text, even if it is not provided by some aggregators, and in this case the contents of the Description field is duplicated. Additional information not cataloged in the form of RSS feeds are extracted from the Description field of the feed by means of suitable search, filtering and comparison algorithms. In particular, they are obtained: a main title, a main news web (for example “repubblica.it”, “corriere.it”), a core text of the news, headlines reported in other news, other news web where the news is reported. In addition, the number of news considered equivalent by the aggregator is stored and the news are grouped in the feed.

At this point, each feed, comprising the aforementioned series of classified information, is considered as an event of the type sought, 206, and in the feed itself are contained, in a form more or less explicit, the main characteristics of the event, for example the geographic location, the moment in which it occurred, the intensity of the event, etc.

If the feed has been distributed in GeoRSS format there are values in the Lat and Lon fields, which indicate the latitude and longitude of the place where the event occurred. In this case, the news is directly cataloged. If instead, as in the great majority of cases occurs, the feed does not contain the information Lat and Lon, it is performed the location of the event in order to be able to apply to the event feed a GeoTag.

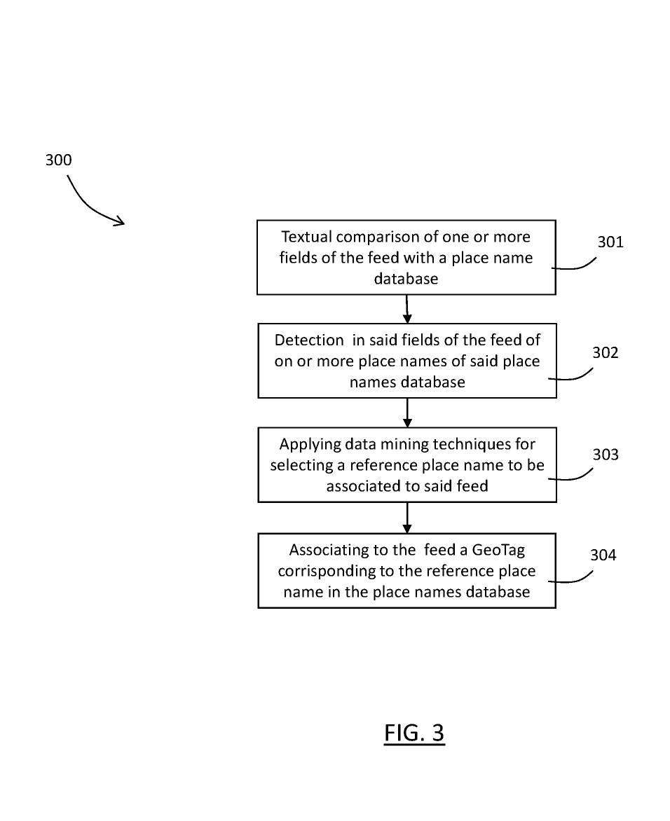

With reference to FIG. 3, the location of the event, 300, takes place through a process of data mining on the fields of the feed. The main procedure provides a textual comparison, 301, between the Description field of the feed and a specially created database of place names organized according to a multiple hierarchy, so as to identify, 302, in the Description field one or more names of such database. For each of the names identified is then calculated a score based on several factors. Some of these factors relate to the text of the news (of the Description field) and are, for example, the evaluation of words that in the phrase are located close to the place name, the presence of capital letters, the position of the place name in the sentence, the position in the text (for example if the name is in the title), articles or prepositions introducing it, the number of times the name appears in the sentence. Additional factors influence the score assigned to the name. For example, there is the possibility that the word found is not actually a place name. Possible alternative meanings of the name are then tested (for example, if in the reference language it is a word that makes sense, or if it is a proper name of person).

In addition, other factors that affect the score are derived from the structure of the peculiar multiple hierarchy place name database. In fact, for example, it is taken into account the territorial coverage of the news web that reports the news, such news webs, as mentioned above, are obtained from the feed, and if the name is located within the coverage of one or more news web then his score is increased. In addition, the presence of place names belonging to the same hierarchical chain increases the score of the place name having fewer territorial extension. Once you have rated all the place names identified it is selected the one that has the highest score and the score of the latter is compared with the score of any other names. In the case that more place names are present of similar score belonging to the same hierarchical chain of the first one it is selected the one at lower level, i.e. of lesser territorial extension.

Once the name reference has been selected, 303, based on the application of these techniques of data mining, it is associated with the feed geotag, 304, using the geographic coordinates associated with the name in the database of place names.

In some cases through the information contained in the news feed it is not possible to identify a place-name reference. In this case, the method of the invention provides for the location of the feed even in the absence of a place name reference, using alternative procedures to search for the localization of the newsletter issuer, or search for adjectives, suggestions or equivalences not directly expressible as geographical place name.

When the process of localization of the news, and then of the event, is completed the feed of news in GeoRSS format is cataloged in the database of geohazards along with additional information that include, for example longitude and latitude of GeoTag, the name selected, the type of place (city, mountain, river, etc.) associated with the name in the database of place names.

In the process of cataloging the event, 400 are assigned to the latter, following the execution of further data mining procedures, a number of scores that, defining the relevance, reliability and accuracy of positioning, allows set filters to exclude events less reliable.

A score, which we call “place score” is calculated, 401, to determine how reliable the GeoTag assigned to the feed. It Is used as a base the score of the name calculated during the localization process of the news. For example, the presence of additional toponyms belonging to a different hierarchical chain and having a score similar to that of the name selected decreases the score, the manual assignment of GeoTag gives the maximum score, the detection of a foreign name as name lowers the score to a minimum value, etc.

Another score, which we call “event score” is calculated, 402, to determine the probability that the feed relates to an event of the type of geological event sought. To calculate this score it is analyzed the text of the news to find specific words or phrases whose presence raises or lowers, in a weighed way, the score of the event. The calculation of the event score is important because it allows to eliminate the feeds that include the words relating to the type of event sought but used with different meanings. In fact, the possibility that news are found that does not really concern the event of interest is quite high, especially if the search string in the search engine contains synonyms and variations of the definition of the event.

Another score, which we call “date score” is calculated, 403, to determine the relevance of the news function of the distance in time between the occurrence of the event and the publication of the news. Even in this case it is analyzed the text of the news to search for specific words or phrases that contain a time reference (e.g. “two days ago”, “18 May 2012”, “last week”, etc.).The date score is calculated as an integer value that represents the distance in days between the event and the publication of the news. A positive value represents an event that happened in the past with respect to the publication of the news and the larger the absolute value and less relevant is the news. A positive value of the score of dating is a future event (such as planned or expected) and it is considered not relevant. The “date score” is used to determine the date of occurrence of the event derivable from the date of publication of the news, taking into account the temporal locutions existing within the same.

Another score, which we call “number of news”, is also calculated, 404, to determine the media coverage of the event, indirect index of the intensity of the same. As “number of news” may be simply assumed the number of equivalents already calculated by the feed aggregator, or it can be calculated in a different way.

According to a preferred embodiment of the invention, the intensity of the event is defined by evaluating at the same time various factors thanks to which it is possible to evaluate the intensity of the event in a very accurate way.

First, the calculation of the number of news takes into account a factor called “reliability of source” from which the news is issued. A score is assigned to the various sources of news in the internet, for example, assigning a higher score to newspapers and a lower score to unofficial sources such as blogs or similar. The news is this way “weighted” by multiplying it by a coefficient proportional to the reliability of the source from which it comes.

From the weighed number of news, the intensity of the event can then be calculated taking into account additional factors from which, for example, appropriate multiplicative coefficients can be obtained. For example, a factor that affects the calculation of ‘Intensity of the event can be the “geographic location of the event.” In fact, in the case of a hazardous geological event as an earthquake, for equal absolute intensity of the event, the media echo and therefore the number of news related will be greater the more the event takes place in a densely populated area. In this case, may be defined by a coefficient decreasing with the increase of population density in the place in which the event occurred.

Similarly, for equal absolute intensity of the event, the media echo of the same will be greater the more severe are the effects on the population (dispersed, injured, deceased). Also in this case an appropriate coefficient, called the “index of the actual effects” is used to correct the “number of news” and therefore the intensity of the event, taking into account the changes in echo media due to the real effects of the event (on population or on tangible or natural goods).

In some cases, an event of high intensity is reported in the news for a prolonged period of time and therefore has a high media coverage temporally distributed, possibly due to collateral events depending on the main one. For this reason it is useful to define another factor that leads to an increase of the intensity of the event and which takes into account the above. The above factor can be calculated from the detection of groups of news, temporally close (i.e. detected within a given time distance from each other), which have substantially the same geographic positioning. In this case, instead of associating the groups of news to a new event (which would be in all probability a collateral event) they are associated with the first event of the series and a variable factor “duration of the news” that raises the intensity of the event is defined.

Finally, to determine the values which must assume the individual coefficients derived from each of the above factors or to determine the method of calculation of the same are advantageously monitored events sample whose position and intensity are defined and measured with conventional instruments, in such a way that the definition and/or the calculation of the factors has an experimental ground.

For each of the above scores are defined threshold values and then a comparison is run between the calculated score and the respective threshold value, 405. The comparison between the calculated scores and the respective threshold values is used to run a filter, and then to exclude from the database events with low reliability. For example, to the date score is set to a first threshold value to exclude news reporting events too far in the past and a second threshold value to exclude events in the future (as they can be only predictions and not true events).Furthermore, the comparison between the calculated scores and the respective threshold values is also useful to have more characteristics information of the event as, for example, the “number of news” provides an information on the relevance in the media of the event which is an indirect measure of ‘intensity of the event.

The cataloging of the event, 406, is then carried along with their scores, after running a check on the presence of duplicate events. To avoid duplicates are checked some fields of the feed of the event, for example: Id, Title, Permalink, Content.

Finally, the news cataloged can be advantageously visualized through a WebGIS system set to take into account the scores with which the event news were cataloged and with which it is possible to manually intervene on the cataloging of single news in order to improve the result obtained automatically.

The method of creation of databases of hazardous geological events described above allows for the creation and automatic updating of the database without the need to prepare the area by providing event detection devices. The method allows to exploit the prevalence of news on the web and through the application of specific data mining processes allows you to record hazardous geological events from related news about the event. In practice, the peculiar use of data mining processes allows to extract from internet event news and examine them carefully so that you can match with a reasonable reliability the event news with the event itself. In addition, the news themselves, always through appropriate processes of data mining extracts the main data of the event, including at least the time and place in which it occurred and the intensity of the same. In particular, the intensity of the event can be measured in a reliable manner without the use of dedicated instrumentation by using the mediatic echo of the event and using a series of correction factors whose values and the calculation of which are rendered increasingly more accurate also using experimental data.

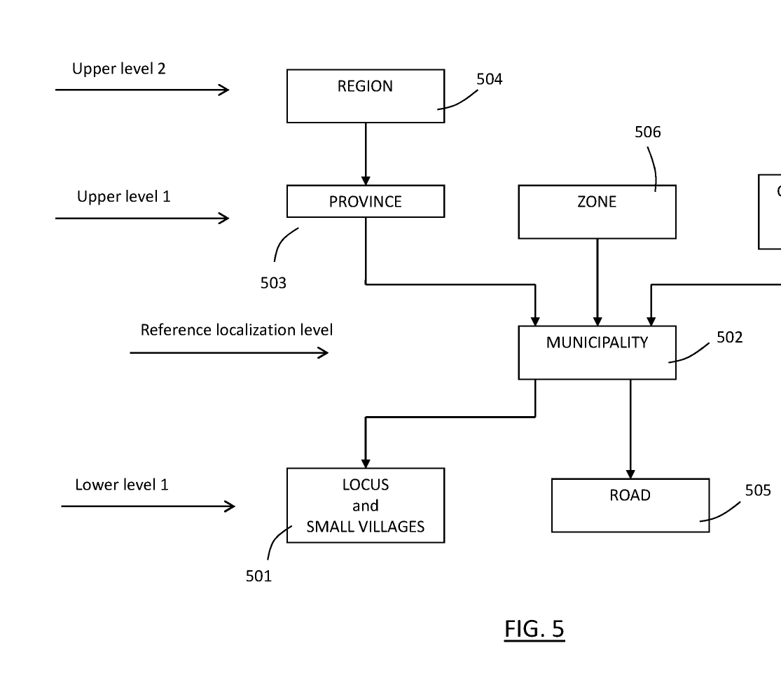

With reference to FIG. 5, according to a preferred embodiment of the invention the database of place names used in the localization process event provides a list of names of various types including at least names of locations, and small cities, 501, names of administrative units at various levels of aggregation such as district or municipalities, 502 provinces and regions 503, 504, street names, 505, names of rivers, lakes, mountains, and other geographical areas, 506, postal codes. Each of the names found in the database is located in a predefined geographic coordinate system, preferably the WGS84 system, and each name is also associated with a geometric definition that can be a point, line or area depending on the geographic entity that the name represents. In addition, the names found in the database are organized hierarchically according to a plurality of hierarchical categories. A first category consists of a hierarchical administrative division, for example in Italy in municipalities or districts, counties and regions. More hierarchical categories are identified in geographic areas 506 such as historical regions, valleys, mountain communities, tourist areas. In the case of these additional hierarchical categories, unlike what happens in the administrative hierarchical category, the belonging of a place name to a name of higher level of aggregation may not be exclusive.

In addition, a database of place names used in the method of the invention advantageously provides also information on the geographical location of the news web, 507, in which are sought news of event, data that are used in the data mining process which leads to the location of the news.

With a database as defined above the process of geo-location can advantageously operate in the manner that follows. It Is defined as a certain level of geographic aggregation, which will be associated with the events. For example, the goal of the localization process can be the association of each event to a name that is on the level of aggregation “municipality” 502, which is stored in the database and is represented as a separate polygonal entity. This polygonal entity reference may be part of upper level polygonal entities, such which province 503, region 504, geographical area 506, area of competence of a news web 507, in different hierarchical categories. The reference polygonal entity 502 can in turn contain further geographical entities of the lower level which can be of type area, line or point, such as locus and smaller villages 501, roads 505 or other small geographic entities.

The data mining process via which the location of the event is performed provides therefore that in the news are sought names of the place names database and that the event is associated in each case with a name of the predefined level of aggregation for example (municipality) thanks multiple hierarchy structure of the place names database. Thanks to this type of structure, moreover, the reliability of the localization can be assessed as it can be assigned a score and a weight to some factors such as the presence in the news of more place names belonging, in different levels of aggregation, to the same hierarchical chain.

Certainly the benefits associated with a method of automatic creating and updating databases of hazardous geological events according to the invention as described above remains safe as a result of amendments or variations thereto.

Indeed, as will be easily understandable, a method according to the present invention can be suitably modified and applied profitably for the creation of databases of events of type also very different, subject however to have a media echo in the internet. In addition, the territorial extension of the database can be arbitrarily defined by setting the appropriate search parameters and also appropriately selecting a place name database.

In fact, as easily comprehensible, the steps of the method and the data mining techniques described above may be subject to modifications, additions and refinements, always remaining within the scope of protection defined by the claims that follow.

1.-10. (canceled)

11. A method for the automatic creation and updating of databases of events that have a mediatic echo in the Internet such as landslides, earthquakes or floods, comprising the steps of:
acquisition of Internet news related to a particular type of event, the acquisition taking place due to an execution of a feed aggregator based on one or more search parameters;
definition of each feed returned as an output from the feed aggregator as an event of that type of event;
association with any feed, that does not contain position information, of position information following a comparison of information contained in the feed with a placenames database or further processing of the information contained in the feed;
cataloging of each event in a database together with characteristic parameters of the event comprising at least a location of the event, a date of the event and an intensity of the event, the parameters being determined by data mining techniques performed on the feed that identities an occurrence of the specific type of event; and
cyclic repetition of any of the previous steps according to a pre-determined time interval.

12. The method according to claim 1 wherein the step of acquisition of Internet news includes the steps of:
searching on the Internet for news related to a particular type of event within a given list of web addresses, by means of feed aggregators, in which the search is performed depending on the search parameters consisting of complex queries, each comprising a plurality of keywords;
grouping of search results using algorithms for classification and clustering;
returning the grouped results, each group being expressed in the form of a feed;
interpretation of each feed by a feed reader program; and
identification of each feed with an event of the determined type of events.

13. The method according to claim 11, wherein the step of association to a feed of position information comprises the steps of:
textual comparison of one or more fields in the feed with a placenames database;
identifying in the fields of the feed of one or more placenames present in the placenames database;
application of data mining techniques to select among these identified placenames, one or more reference placenames to be associated with the feed;
selection, from the one or more placenames, the name of the main reference place name through an appropriate algorithm; and
association to the feed of a geotag of the feed or a position information of the event, the geotag of feed or position information corresponding in the placenames database to the placename selected, or, in the case that through the analysis of the fields of this feed it is not found a reference placename, the geotag feed or position information being determined through the use of procedures for localization of the news broadcaster, or by searching for adjectives, geographical suggestions or equivalences that are not directly expressible as a placename.

14. The method according to claim 13, wherein the placenames database provides a list of placenames of types including at least the names of towns and small cities, names of administrative units at various levels of aggregation such as municipalities or districts provinces and regions, names of roads, names of rivers, lakes, mountains, and other geographical areas, each of these placenames being located in a predefined geographic coordinate system and each of them being associated with a geometric definition which can be a point, line, or area, the names being hierarchically organized according to a plurality of hierarchical categories.

15. The method according to claim 14, wherein the step of association to each feed not containing a position information of a position information is performed, following the definition of a predefined level of geographical aggregation to which the events must be associated, by means of identification in the feed of placenames found in the placenames database and subsequent association of the event to the placename of the predefined level of aggregation which belongs to the hierarchical chain of the placename identified and selected in the feed.

16. The method according to claim 11, wherein the step of cataloging comprises the steps of:
running, on the feed associated event, data mining techniques suitable to determine characteristic parameters of that event and to exclude from the database unreliable events, the data mining techniques including the steps of:
calculating a place score to determine how reliable is the geotag assigned to the feed;
calculating an event score to determine the probability that the feed relates to the type of event sought;
determining a date score to determine the relevance of the news function of the distance in time between the occurrence of the event and the publication of the news;
determining a number of news to determine the media coverage of the event, indirect index of the intensity of the same;
comparison of the calculated scores with respective threshold values; and
insertion of the event in the database of events, each event being associated with at least a position, date and intensity information obtained either directly or through the above-mentioned data mining techniques from the feed of the event.

17. The method according to claim 16, wherein the characteristic parameters recorded in the step of cataloging comprise the place score, the event score and the date score.

18. The method according to claim 16, wherein the number of news corresponds to the intensity of the event and it is calculated as a function of the number of equivalent news and other factors including at least a reliability of the source.

19. The method according to claim 18, wherein the number of news is calculated as a function of factors including any one of a geographic location of the event, an index of the actual effects and a duration of the news.

20. The method according to claim 11, wherein, at each cyclic repetition of the steps of the method, the step of cataloging of each event in a database of the events together with characteristic parameters of the event comprises the insertion of a new event with the characteristic parameters thereof or the update of the characteristic parameters of an event already present in the database.
